(19) United States
(12) Patent Application Publication
(10) Pub. No.: US 2014/0379223 A1
(43) Pub. Date: Dec. 25, 2014

(54) PEDESTRIAN PROTECTION DEVICE AND METHOD HAVING ADAPTIVE REDUCTION OF COLLISION ENERGY

(71) Applicants: Maja Wolkenstein, Sachsenheim (DE); Gian Antonio D'Addeta, Stuttgart (DE); Josef Kolatschek, Weil Der Stadt (DE)

(72) Inventors: Maja Wolkenstein, Sachsenheim (DE); Gian Antonio D'Addeta, Stuttgart (DE); Josef Kolatschek, Weil Der Stadt (DE)

(21) Appl. No.: 14/368,463

(22) PCT Filed: Dec. 27, 2012
(86) PCT No.: PCT/EP2012/076920

§ 371 Date: Jun. 24, 2014

(30) Foreign Application Priority Data
Dec. 27, 2011 (DE) 10 2011 089 992.8

(51) Int. Cl. B60R 19/34; F16F 7/12; B60R 21/34

(52) U.S. Cl. CPC B60R 19/34; B60R 21/34; F16F 7/12
USPC 701/45; 293/133; 180/271

(57) ABSTRACT

A passenger protection device for a vehicle includes: an impact absorber for absorbing impact energy, which impact absorber has a cavity for receiving and deforming a deformation element during a movement of the deformation element in an advancing direction which is determined by the impact energy; a blocking element for blocking the movement of the deformation element; and a pedestrian protection device which is coupleable to the deformation element and which is designed to actively move the deformation element by a predetermined distance in the advancing direction based on a deactivation of the blocking element.

### BACKGROUND OF THE INVENTION

1. Field of the Invention

The present invention relates to a passenger protection device for a vehicle including a pedestrian protection device, a method for using a pedestrian protection device which is coupleable and/or coupled to a passenger protection device for a vehicle, a corresponding control unit, and a corresponding computer program product.

2. Description of the Related Art

Recent vehicles have a front end structure which has the task of absorbing the energy which arises during a collision, in such a way that the risk of injury for the occupants is greatly reduced. This energy absorption usually occurs via the deformation of appropriate components in the front end of the vehicle (crumple zone). Thus, the front end structure is deformed to a greater or lesser extent, depending on the severity of the collision. A present aim is to minimize the costs of repairs for minor collisions. For this reason, the vehicle structure is subdivided in such a way that only a small, precisely delineated portion of the front end structure, also referred to as a crash box, is deformed during minor collisions. However, in more severe collisions the entire front end structure takes part in the energy reduction. This process has the advantage that for minor collisions, only this crash box or these crash boxes is/are replaced, while the other components remain undamaged. However, this requires that the energy absorption capability of the crash box be intentionally set relatively low. In the case of a minor collision this has no disadvantages, and at the same time ensures that the remaining front end structure is also not deformed. For more severe collisions, however, the optimal quantity of energy is not absorbed. Therefore, for this case the remaining portion of the structure must compensate for this shortcoming and have a correspondingly more solid design.

Published European patent application document EP 1 792 786 A2 discloses a crash box for insertion between a bumper crossbeam and a longitudinal chassis beam of a motor vehicle. The crash box has a housing-like deformation profile as a folding construction made of sheet metal, and a flange plate on the longitudinal chassis beam side, characterized in that the flange plate is designed as an integral part of the folding construction.

Pedestrian protection is also known in vehicles. Pedestrian protection systems are divided into two categories. On the one hand, there are passive systems, which mitigate the impact solely via structural measures such as a “soft” front end and sufficient deformation space between the hood and the engine. On the other hand, active systems are used, which register an impact with a pedestrian via sensors and then trigger via actuators the protective measures, such as raising the hood. A distinction is made between reversible actuators (which are triggered by magnetic switches) and irreversible actuators (which are triggered via pyrotechnics). In particular an irreversible system requires sensors which trigger very reliably, as well as algorithms, while reversible actuators are also combinable with fairly simple recognition techniques. The active protection systems must meet three main requirements during function testing: first, regulatory requirements must be met; second, sensors and evaluation algorithms must properly classify the various crash dummies (a 6 year-old child, and 5%, 50%, and 95% percentile adults); and third, recognition of other obstructions such as birds, garbage bins, or flying rocks must be possible in order to avoid faulty triggering.

The European Union has mandated pedestrian protection via Directive 2003/102/EC, effective Jan. 1, 2004. This Directive defines in detail four different impact scenarios having different parameters. In a first scenario, an impactor which simulates the lower or upper leg (depending on the body size of the simulated child or adult) strikes the bumper; in a second scenario, an upper leg impactor strikes the front edge of the hood; and in a third and a fourth scenario, a child's head impactor or an adult impactor, respectively, collides with the hood. The impactors are each equipped with sensors. Maximum values are established for the forces which act during impact with the body parts. The Directive stipulates that, effective October 2005, every new vehicle platform for passenger vehicles and light-duty utility vehicles having a total weight of less than 2.5 metric tons must meet the requirements of the lower leg and child's head test by the end of 2012. Phase two has been in effect since September 2010. The specifications for upper leg and head impacts for adults must likewise be completely met by September 2015.

### BRIEF SUMMARY OF THE INVENTION

Against this background, the present invention presents a passenger protection device for a vehicle including a pedestrian protection device, a method for using a pedestrian protection device which is coupleable to a passenger protection device, a control unit which uses the steps of this method in appropriate units, and lastly, a corresponding computer program product.

Front end structures which have a changeable energy absorption level and which appropriately adjust to the severity of the collision avoid the above-mentioned disadvantage of the low energy absorption capability of crash boxes. These types of structures are therefore also referred to as adaptive crash structures.

An adaptive crash structure may operate on the basis of a tapered absorber. In this case, in the event of a collision a deformation element such as a tube is pushed through one or multiple cavities situated in a housing, and is thus deformed or tapered in order to thus effectively reduce the impact energy. As the result of effectively activating and deactivating cavity plates, the taper diameter may be varied, and the rigidity of the crash structure may thus be modified. For example, a cavity used for a second tapering stage of the structure may be disengageable, i.e., pushed outwardly when a support is removed, due to a radial force on the deformation element. The force level of the crash structure is therefore lower, and less impact energy is reduced.

Examples of implementation of the principle of an adaptive crash structure are found, for example, in a crash structure having adaptive energy absorption due to removal of reinforcing ribs via a cutting process or by tapering. An adaptive crash box may have an integrated pressure sensor, or alternatively, a sensor configuration which, with the aid of two acceleration sensors, determines a setpoint rigidity of the adaptive crash box and also triggers the restraint means of the passive safety system. In this regard, it is possible to implement a fast and accurate actuator system for a structure having changeable rigidity.

In particular, according to the tapering principle an existing adaptive crash structure may be supplemented with a pedestrian protection function, in that the severity of injury for the pedestrian may be reduced by active retraction of a front end structure of a vehicle.

According to the approach presented here, an improvement in the pedestrian protection may be achieved due to the possibility for reducing the contact forces which arise during a collision between a pedestrian and a vehicle via an active element which acts on the bumper. A particularly noteworthy feature of this approach is the possible combination of this type of pedestrian protection device with the adaptive crash structure (ACS).

In contrast to conventional pedestrian protection systems which are accommodated in the bumper, such as the “soft front end,” in the approach presented here the protective effect may develop without relying primarily on the shape of the front end of the vehicle structure or padding, for example by installing foam or other plastic elements in the potential area of contact of the vehicle with a pedestrian. Limitations in the freedom in the design of vehicle front ends may thus be avoided. In addition, extra installation space which would have to be provided for the padding and which would result in an overall lengthening of the vehicle may be saved. Since the active element retracts the bumper at the moment of contact with the pedestrian, and this retraction speed is subsequently reduced, the system proposed here acts de facto as padding, for example using foamed plastic which may have a similar force-displacement characteristic during deformation, but without the associated disadvantages. In addition, with the approach proposed here the disadvantage may be overcome that pedestrian protection systems made of plastic may have a different characteristic, depending on the temperature, thus making the protective effect for the pedestrian dependent on the temperature. Furthermore, an additional improvement or individualization of the protective effect is easily achievable with the technical approach proposed here, since in principle any desired force-displacement characteristics may be predefined. For example, individualization may be achieved in that, via a suitable sensor system, certain pedestrian characteristics such as size, mass, etc., may be detected and, using a suitable computing program, a force-displacement characteristic curve which is optimal for these features is computed and used to act on the actuator.

The technical concept presented here provides an alternative to mere deactivation of a crash box, i.e., setting a force level of zero. The situation may be effectively prevented that the bumper-crossbeam assembly is freely movable in a manner of speaking, and may be pushed on by the pedestrian. Thus, there is no longer the disadvantage that a significant force is exerted on the pedestrian due to mass inertia of the assembly. For a mass of 3 kg and a vehicle speed of 40 km/h, for example, this would be equivalent to an impact of a blow from a 3-kg hammer moved at 40 km/h. Via the active retraction according to the present invention of this assembly presented here, this mass inertia effect during the interaction with the pedestrian may be effectively avoided, so that stress to the pedestrian no longer occurs in a singular manner, and instead may be “ramped up.”

In addition, using the approach presented here, initially moving the front end structure slightly forward prior to the collision with the pedestrian in order to subsequently reduce the force during the collision over a longer path which is now available may be dispensed with. An anticipatory sensor system may thus have a simpler design or may even be dispensed with, since the case of the anticipatory sensor system triggering too late and the pedestrian colliding with an element which at that moment is moving forward, which would even result in increased severity of injury, may be ruled out in the approach proposed here. By use of the present invention proposed here, a system for pedestrian protection which is significantly less complicated may be implemented.

Moreover, via the system according to the present invention, the basic functionality of the ACS may be meaningfully bundled with the pedestrian protection without the need for an additional sensor system, resulting in a double benefit.

The present invention provides a passenger protection device for a vehicle, having an impact absorber for absorbing impact energy, the impact absorber having a cavity, in particular a nondisengageable cavity, for receiving and deforming a deformation element during a movement of the deformation element in an advancing direction which is determined by the impact energy, and a blocking element for blocking the movement of the deformation element, and the passenger protection device having the following feature:

a pedestrian protection device which is coupleable to the deformation element and which is designed to actively move the deformation element by a predetermined distance in the advancing direction, based on a deactivation of the blocking element.

The passenger protection device may be installed in the front end of the vehicle, for example, and used, for example, when the vehicle collides with a stationary object or a moving object such as another vehicle or also a pedestrian or cyclist. The vehicle may be a passenger vehicle or a utility vehicle, for example. For example, the passenger protection device may replace a longitudinal chassis beam or part of a longitudinal chassis beam of the vehicle.

The impact absorber may have a housing with an opening for receiving the deformation element into the housing and a further opening, situated opposite from the opening, for the deformation element to exit from the housing. The housing may have an outward bulge for accommodating the nondisengageable cavity within the housing. The housing may completely enclose the deformation element or parts thereof during the movement of the deformation element in the advancing direction. The impact absorber may be a tapered absorber which is based on the principle of a deformation, in the present case tapering, of the deformation element during the movement of the deformation element in the advancing direction through the housing and the nondisengageable cavity in order to thus absorb and reduce the impact energy. The impact energy is a function of the severity of an occurring collision, which in turn is due to the vehicle speed, mass, and travel direction, etc., of the colliding objects. If the impact absorber also has an activatable further tapering stage in addition to the nondisengageable cavity, it may be implemented as an adaptive crash box which may have various rigidities as a function of an ascertained collision severity. In the event of a severe collision with activation of the further tapering stage, the impact absorber may accordingly have a high rigidity and thus cause extensive deformation of the deformation element. A large amount of impact energy may thus be reduced. In a minor collision, the impact absorber may have a low rigidity with omission of the second tapering stage. The deformation of the deformation element may thus be low, since less impact energy has to be absorbed.

The deformation element may be designed as an elongated component having, for example, a circular cross section. In response to the collision, the deformation element may be moved along its longitudinal axis through the housing of the impact absorber in the advancing direction, and in the process, received by the nondisengageable cavity and deformed or tapered in order to absorb the impact energy.

The nondisengageable cavity may be designed in the form of a ring, for example, whose opening faces the deformation element. A clearance of the nondisengageable cavity in the ring shape may be smaller, at least in part, than a cross section of the deformation element prior to entry into a deformation section or tapered section of the nondisengageable cavity. An outer wall of the nondisengageable cavity may be supported with respect to an inner wall of the housing. An inner wall of the nondisengageable cavity may extend completely or partially obliquely, for example, so that the nondisengageable cavity forms a type of funnel which may result in the tapering of the deformation element while it moves in the advancing direction along the inner side of the nondisengageable cavity due to the collision. The advancing direction may be oriented opposite to a travel direction of the vehicle. The advancing direction may essentially correspond to an impact direction on the vehicle. The blocking element may be situated in the housing of the impact absorber, downstream from the nondisengageable cavity in the advancing direction. In a neutral position of the passenger protection device, the blocking element may be designed to be in a first position in which it may support an end area of the deformation element which is at the front in the advancing direction, and may prevent a movement of the deformation element in the advancing direction. For this purpose, the blocking element may have a smaller clearance, at least in part, than the nondisengageable cavity.

The pedestrian protection device may be designed to protect a pedestrian who collides with the vehicle from severe injuries, in that it causes retraction, which is optimal with regard to speed and extent, of the deformation element and other vehicle structures which the pedestrian contacts at the moment of the collision. The term “pedestrian protection device” is not to be construed as limited to protection of pedestrians; rather, the protective effect also includes, for example, other road users who collide with the vehicle, for example, and who are exposed to a high risk of injury, such as cyclists, or also wild animals crossing the roadway. In addition, the pedestrian protection device may also be meaningful for a minor collision of the vehicle with an inanimate stationary object. The blocking element may be deactivated by moving it from the first position, in which it supports the deformation element, into a second position in which it enables the deformation element. The deformation element and other vehicle structures connected to it may thus be moved by the predetermined distance in the advancing direction and carry out the injury-reducing retraction with respect to the colliding road user.

In principle, the passenger protection device may be situated in the front end and/or the rear end of the vehicle.

According to one specific embodiment, the deformation element may have a pretapered area. A length of the pretapered area may correspond to a length of the predetermined distance. In addition, a diameter of the deformation element in the pretapered area may be less than a clearance of the nondisengageable cavity. It may thus be advantageously ensured that the pedestrian protection device may be used independently of a vehicle occupant protection area of the passenger protection device, and thus used reversibly.

The pedestrian protection device may have an actuator which is designed to continually exert a force of motion on the deformation element for moving the deformation element by the predetermined distance. Connecting the tube to the remaining structure via the deformation element/actuator may prevent, for example, the tube from falling out of the cavity during normal operation. The actuator may be connected or connectable to the deformation element. This specific embodiment offers the advantage that an energy potential which is necessary for moving the deformation element in the event of a collision is already available, and does not have to be generated first. A particularly short response time of the pedestrian protection device is thus achievable.

The actuator may be a tension spring, for example. A first end of the tension spring may be fastenable to the deformation element, and a second end of the tension spring may be fastenable to an element of the passenger protection device situated upstream from the deformation element in the advancing direction, generating a tensile stress. A spring excursion of the tension spring in the fastened state may correspond to the predetermined distance of the deformation element. A particularly robust and cost-effective actuator may be implemented by using a tension spring, for example a coil spring.

When a spring or an element having a similar functional principle is used as the actuator, the pedestrian protection device may have at least one pin. This pin may be situated with respect to the spring in such a way that the pin influences a force-displacement characteristic of the spring in a predetermined manner when the blocking element is deactivated. The pedestrian protection device may thus be advantageously set to a previously detected specific size and/or mass of the colliding road user.

Alternatively, the pedestrian protection device may have an actuator which is designed to exert a force of motion on the deformation element for moving the deformation element by the predetermined distance in response to an actuation. This may be a pyrotechnic, electric, or magnetic actuator, for example. Such a specific embodiment of the present invention offers the advantage that an option for a quickly responding actuator is provided. In addition, a force which to some extent is very well controllable may be provided by such an actuator.

According to one exemplary embodiment, the blocking element may be a disengageable cavity. This disengageable cavity may be designed to be deactivated in that it is enabled to disengage in response to an impact signal. The nondisengageable cavity may be designed in the form of a ring, for example, whose opening faces the deformation element. The disengageable cavity may be designed to disengage upon penetration of the deformation element when the passenger protection device is not set to the high rigidity level. The disengageable cavity may be situated in the housing in such a way that an outer wall of the disengageable cavity is separated by a distance from an inner wall of the housing. Upon disengagement, the disengageable cavity may be pushed away from the deformation element, i.e., pushed toward the inner wall of the housing, by a radial force of the penetrating deformation element, thus causing no tapering of the deformation element. Such a movement of the disengageable cavity, which occurs essentially transversely with respect to the advancing direction, is referred to as “disengagement” of the cavity in the present description. The disengagement of the disengageable cavity due to the radial force of the deformation element may be made possible, for example, in that a support device for the disengageable cavity is removed or changed in its position. Via the disengagement, the disengageable cavity may enable the deformation element for the movement in the advancing direction. For a uniform, controlled disengagement, the disengageable cavity may be composed of multiple segments or may have uniformly spaced predetermined breaking points. The use of a disengageable cavity as the blocking element is advantageous, since it is installed anyway in a conventional adaptive crash structure. Thus, no additional installation space for installing a separate blocking device is required.

Moreover, the present invention provides a method for using a pedestrian protection device which is coupleable and/or coupled to a passenger protection device for a vehicle, the passenger protection device having an impact absorber for absorbing impact energy, and the impact absorber having a cavity, in particular a nondisengageable cavity, for receiving and deforming a deformation element during a movement of the deformation element in an advancing direction which is determined by the impact energy, and a blocking element for blocking the movement of the deformation element, and the method having the following steps:

deactivating the blocking element in order to enable the deformation element; and

actively moving the deformation element by a predetermined distance in the advancing direction in order to use the pedestrian protection device.

The method may be carried out, for example, in conjunction with a control unit which may be connected to or integrated into the passenger protection device described above. For example, the blocking element may be deactivated by removing or displacing one or multiple support devices for the disengageable cavity based on a signal of the control unit, such as an impact signal. The object underlying the present invention may also be quickly and efficiently achieved by this embodiment variant of the present invention in the form of a control unit.

According to one specific embodiment, in the step of the active movement, a magnitude of a speed of the movement of the deformation element may be reduced from a first speed, which approximately corresponds to a speed of the vehicle, to a second speed which is approximately zero. In this way, the pedestrian may be prevented from bouncing off the vehicle, thus further reducing the risk of injury.

In the present context, a control unit may be understood to mean an electrical device which processes sensor signals and outputs control signals as a function thereof. The control unit may have an interface which may have a hardware and/or software design. In a hardware design, the interfaces may be part of a so-called system ASIC, for example, which contains various functions of the control unit. However, it is also possible for the interfaces to be dedicated, integrated circuits, or to be at least partially composed of discrete components. In a software design, the interfaces may be software modules which are present on a microcontroller, for example, in addition to other software modules.

Also advantageous is a computer program product having program code which may be stored on a machine-readable carrier such as a semiconductor memory, a hard drive, or an optical memory, and used for carrying out the method according to one of the above-described specific embodiments when the program is executed on a computer or a device.

The present invention is explained in greater detail below as an example, with reference to the appended drawings.

### BRIEF DESCRIPTION OF THE DRAWINGS

FIG. 1 shows a schematic illustration for explaining a passive pedestrian protection device for a vehicle.

FIGS. 2A to 2C show illustrations in the longitudinal section of an adaptive impact absorber.

FIGS. 3A and 3B show illustrations in the longitudinal section of a passenger protection device according to one exemplary embodiment of the present invention.

FIG. 4 shows a graph for illustrating pretensioning of a tension spring as the actuator of the passenger protection device from FIGS. 3A and 3B.

FIG. 5 shows a graph for illustrating the leg acceleration in a conventional system compared to the passenger protection device from FIGS. 3A and 3B.

FIG. 6 shows a schematic illustration for explaining an active retraction of a front end structure with the aid of an adaptive impact absorber having pedestrian protection according to one exemplary embodiment of the present invention.

FIG. 7 shows a schematic illustration of a vehicle having a passenger protection device according to one exemplary embodiment of the present invention.

FIG. 8 shows a flow chart of a method for using a pedestrian protection device which is coupleable and/or coupled to a passenger protection device for a vehicle, according to one exemplary embodiment of the present invention.

### DETAILED DESCRIPTION OF THE INVENTION

In the following description of preferred exemplary embodiments of the present invention, identical or similar reference numerals are used for the elements having a similar action which are illustrated in the various figures, and a repeated description of these elements is dispensed with.

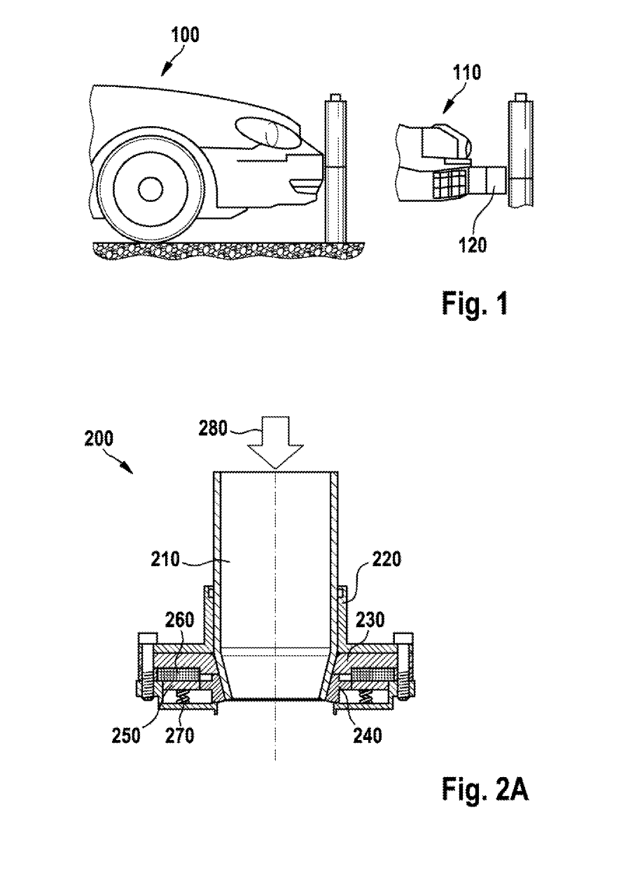

FIG. 1 shows a schematic illustration for explaining a passive pedestrian protection device for a vehicle according to the related art. The figure shows a front end of a vehicle 100 during a collision with a post, which in the present case represents a leg of a pedestrian, for example. The left section of the drawing shows the body of vehicle 100, and the right section of the drawing shows a structure 110 of vehicle 100 concealed in the bumper of vehicle 100. The section on the right shows a view of vehicle 100, but without the outside panel and bumper. Structure 110 is installed in a potential contact area of vehicle 100 with a pedestrian, and has padding in the form of a foam element 120; foam element 120 may be interpreted as a pedestrian protection device. During a collision with the post or a pedestrian, the impact energy may be absorbed by foam 120 in that the foam is compressed during the collision or impact.

The adaptive crash structures explained below replace portions of existing front end structures in motor vehicles. For example, the structures proposed herein may replace the crash box and the front portion of the longitudinal chassis beams.

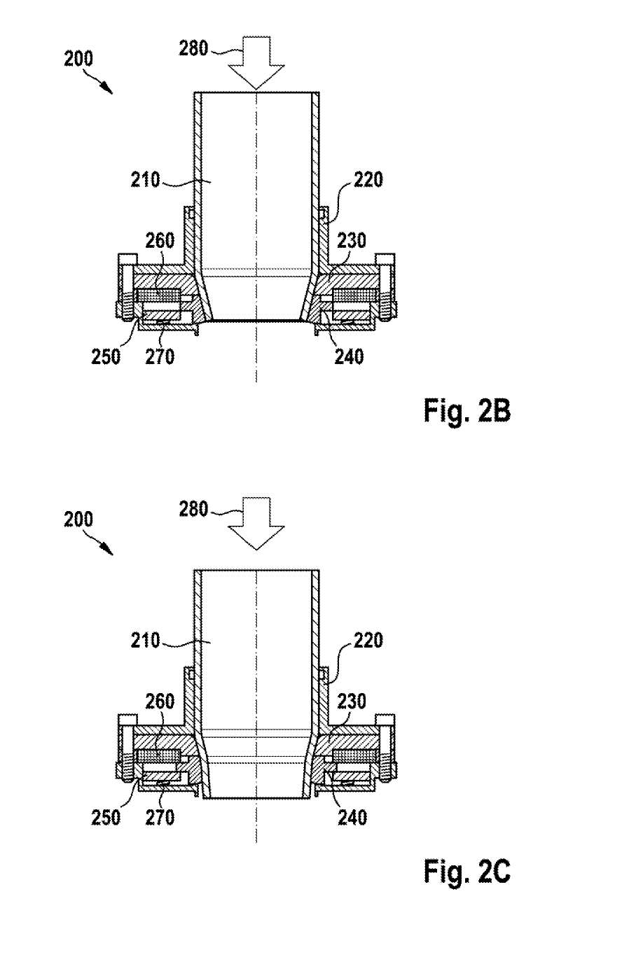

FIGS. 2A through 2C explain the basic functionality of an adaptive crash structure 200 for absorbing impact energy, with reference to schematic illustrations in the longitudinal section. The illustrations in FIGS. 2A through 2C each show a longitudinal section of crash structure 200 or the impact absorber having a settable rigidity, which may be installed, for example, in the front end of a vehicle. Adaptive crash structure 200 includes a deformation element 210, which is designed as a tube here, as well as a housing 220 in which a fixed, i.e., nondisengageable, cavity 230 and a crushable or disengageable cavity 240 are situated. In addition, impact absorber 200 includes a ring 250, which is displaceable within housing 220, for supporting and enabling disengageable cavity 240, a current-conducting coil 260 situated adjacent to ring 250, and a spring element 270 situated between ring 250 and another wall of housing 220. An impact direction or advancing direction 280 of deformation element 210 along its longitudinal extent, denoted by a dash-dotted line, is denoted by an arrow in the illustration. The dash-dotted line also marks a center axis of crash structure 200.

In a first aspect, adaptive crash structure 200 has two rigidities. The base setting of structure 200 is the higher rigidity, which corresponds to the rigidity of a front longitudinal chassis beam of the vehicle. The second setting to which a switchover is made has a lower rigidity. It is likewise possible to install adaptive crash structure 200 farther to the rear in the front end structure, i.e., as a replacement of a rear longitudinal chassis beam. Structure 200 may likewise be used for the vehicle rear end, even though only the front end is considered herein.

In the case of high impact speeds and thus high collision energies, it is advantageous to achieve a high energy absorption level early, for which reason the higher rigidity as the base setting is meaningful. In the case of low collision energies, a lower rigidity is necessary so that structure 200 may be deformed by the smaller transmitted force. This results in advantages in the stress to occupants in the form of a stress which is lower in intensity but longer in duration. The two levels are set with the aid of an actuator.

FIG. 2A shows a sectional view of adaptive crash structure 200 in the neutral position. In the present case, ring 250, which is displaceable within the housing, is situated between disengageable cavity 240 and a wall of housing 220, so that disengageable cavity 240 is supported. During a collision, tube or deformation element 210 is pushed into fixed cavity 230 and into crushable cavity 240, and greatly tapered in the process.

FIG. 2B shows a sectional view of adaptive crash structure 200 in the actuated position. In the present case, ring 250 is shifted downwardly in response to a current flow in coil 260. If a collision now occurs, tube 210 likewise penetrates into fixed cavity 230 and into crushable cavity 240. Since ring 250 does not support crushable cavity 240, the crushable cavity may be crushed, for example at predetermined breaking points, due to the action of the radial force by tube 210, and may disengage. Thus, the degree of tapering of tube 210 is lower compared to the base setting shown in FIG. 2A.

FIG. 2C shows a sectional view of adaptive crash structure 200 in the collision case, specifically, for a soft setting, i.e., low rigidity, as explained with reference to the illustration in FIG. 2B.

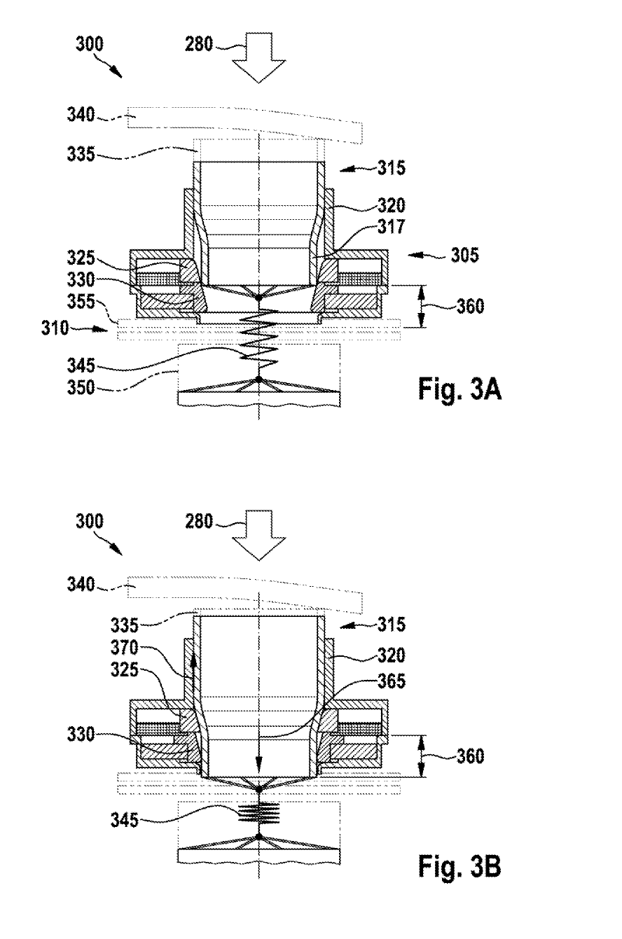

FIGS. 3A and 3B explain, likewise with respect to longitudinal sectional illustrations, a functionality of a passenger protection device 300 in the form of an adaptive crash structure having active pedestrian protection according to one exemplary embodiment of the present invention. Two switching states of passenger protection device 300 are illustrated: specifically, FIG. 3A shows structure 300 prior to a collision and FIG. 3B shows structure 300 after the collision. The collision shown with reference to the illustrations is a simulated impact of a pedestrian with a vehicle, using a leg impactor.

FIG. 3A shows passenger protection device 300 in the neutral position prior to an impact, in which it is set to the high rigidity. Passenger protection device 300 may be installed, for example, in the front end of a vehicle, and may include or be connected to portions of the front end of the vehicle.

Passenger protection device 300 includes an adaptive impact absorber 305 and a pedestrian protection device 310. With regard to the arrangement and function of the elements, impact absorber 305 essentially corresponds to the crash structure explained with respect to FIGS. 2A, 2B, and 2C, and includes a deformation element 315 having a pretapered area 317, a housing 320, a primary or nondisengageable cavity 325, and a secondary or disengageable cavity 330. In the exemplary embodiment of passenger protection device 300 shown in FIGS. 3A and 3B, disengageable cavity 330 forms a blocking element of passenger protection device 300, in that in the nondisengaged position shown in FIG. 3A, it prevents a movement of tube 315 in advancing direction 280, since a clearance of the disengageable cavity in the nondisengaged position is smaller than a cross section of the pretapered area of deformation element 315. Alternatively, another element of passenger protection device 300 may form blocking element 330.

Deformation element 315 is connected to an elastic element 335 at a rear end in advancing direction 280. Deformation element 315 and thus impact absorber 305 are coupled to a crossbeam 340 of the vehicle via elastic element 335. Elastic element 335 and crossbeam 340 are illustrated in FIG. 3A by dashed lines and dash-dotted lines, respectively, since for reasons of clarity, deformation element 315 is illustrated in greatly shortened form, and therefore elements 335 and 340 are not actually situated in the position shown in FIGS. 3A and 3B. An actuator 345 of pedestrian protection device 310 is connected between deformation element 315 and a rear longitudinal chassis beam 350 of the vehicle via fastening devices. Instead of rear longitudinal chassis beam 350, some other element of a crash structure of a vehicle may be used as the fastening point for actuator 345. A front area of housing 320 of adaptive crash structure 305 in advancing direction 280 rests against a deflector plate 355, likewise illustrated here by dashed lines.

In the exemplary embodiment of passenger protection device 300 shown in FIGS. 3A and 3B, actuator 345 is a tension spring.

In the neutral position of passenger protection device 300 shown in FIG. 3A, pretapered tube 315 rests on lower, i.e., disengageable, cavity 330. Spring 345, which at one end is fastened to pretapered area 317 of deformation element 315 and at the opposite end fastened to longitudinal chassis beam 350, is pretensioned with a predetermined force over a predefined distance. Thus, potential energy for moving deformation element 315 and the elements coupled thereto is stored in spring 345. A double arrow in the illustration denotes one possible displacement distance 360 of deformation element 315 which is based on the pretensioning of spring 345, and which in the exemplary embodiment shown here is 22.5 mm.

FIG. 3B shows passenger protection device 300 from FIG. 3A after the collision or impact. Events which result in the state of passenger protection device 300 illustrated in FIG. 3A are described below.

Lower cavity 330 is enabled for disengagement based on a detection of a collision with a pedestrian. As shown in the illustration in FIG. 3B, the signal for disengagement is triggered here by a deformation of elastic element 335 as part of an existing ACS system or a precollision sensor system. Cavity 330 is deformed and pushed radially outwardly due to the great pretensioning of tube 315 resting on lower cavity 330. As a result of the pretensioning of spring 345, tube 315 is subsequently moved by predetermined distance 360 in advancing direction 280, i.e., is pulled backward from the location of the collision, over a very short period of time.

Due to tube 315 being pulled backward by spring 345, the front end structure of the vehicle, which is designated here by crossbeam 340, and which is coupled to deformation element 315, is likewise moved backwardly at a predetermined speed. Therefore, a pedestrian colliding with front end structure 340 is decelerated more slowly, and the severity of injury is reduced.

A tensile force 365 of tension spring 345, denoted by a downwardly pointing arrow in the illustration in FIG. 3B, acts against friction 370, symbolized by an upwardly pointing arrow, of tube 315 against a wall of housing 320 when a nontapered area of deformation element 315 which follows the pretapered area passes nondisengageable cavity 325.

The illustration in FIG. 3B likewise makes it clear that, compared to the original state of passenger protection device 300, in addition the foam padding or elastic element 335 in front of crossbeam 340 is markedly thinner after the collision, i.e., has been compressed. The combination of the retraction of structure 340 and a damped coupling of the leg impactor to the vehicle movement results in significantly less stress to a pedestrian.

As an alternative to the design of passenger protection device 300 described with reference to FIGS. 3A and 3B, active control and movement of disengageable cavity 330 may take place. If a pedestrian collision is detected, lower cavity 330 is actively moved away, thus activating spring 345.

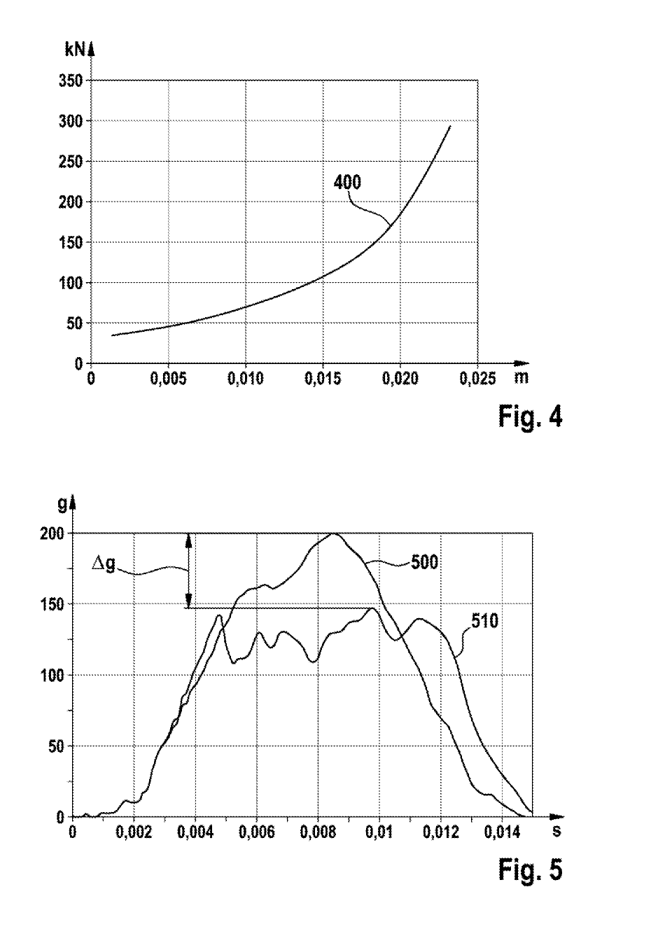

FIG. 4 shows a graph for illustrating pretensioning of the tension spring of the adaptive impact absorber having pedestrian protection from FIGS. 3A and 3B. A coordinate system is shown in which a displacement path of the deformation element is plotted in meters on the abscissa, and an elastic force is plotted in kilonewtons on the ordinate. A curve 400 denotes a depiction of the relationship between a force and a distance, a length of the possible displacement path as a function of the applied pretensioning force increasing disproportionately. It is apparent from the illustration in FIG. 4 that in the neutral state of the passenger protection device, the spring has a pretensioning of approximately 300 kilonewtons in order to allow the predefined displacement path of 22.5 mm indicated in FIGS. 3A and 3B. Thus, potential energy is stored in the spring.

Also conceivable but not shown in the figures are electrical, magnetic, hydraulic, pneumatic, or ceramic energy stores or pressure accumulators, which are controlled via generators, for example. By use of retractable and extendable pins it is also possible, for example, to influence the force-displacement characteristic of springs and adapt them, for example, to the characteristics of a colliding pedestrian. The same applies for the other system implementations.

FIG. 5 shows a graph of a test for comparing the leg acceleration, using a conventional passive system, to the active system of the passenger protection device described here and shown in FIGS. 3A and 3B. A coordinate system is shown in which time is plotted in seconds on the abscissa and the leg acceleration is plotted in units of a multiple of gravitational acceleration on the ordinate. A graph line 500 denotes the variation of the leg acceleration over time for a passive pedestrian protection system, and a graph line 510 denotes the variation of the leg acceleration over time for the pedestrian protection device presented herein. An area between a lower limit of 150 g and an upper limit of 200 g represents a peak stress during a collision of a leg of a pedestrian with a vehicle. A double arrow denotes a leg acceleration increase Ag of 52 g. It is apparent from the graph in FIG. 5 that when the active system proposed here is used, the leg acceleration remains below the peak stress, but extends over a longer time period than is the case for the conventional system. In passive systems, as described above, the pedestrian protection is achieved, for example, by deformation of the front end structure. As a result of the active crash structure in the area of the crossbeam presented here, the stress to the pedestrian may be reduced due to the active retraction of the front end structure. The above-described mass inertia effect of the accelerated front end structure is essential in this regard.

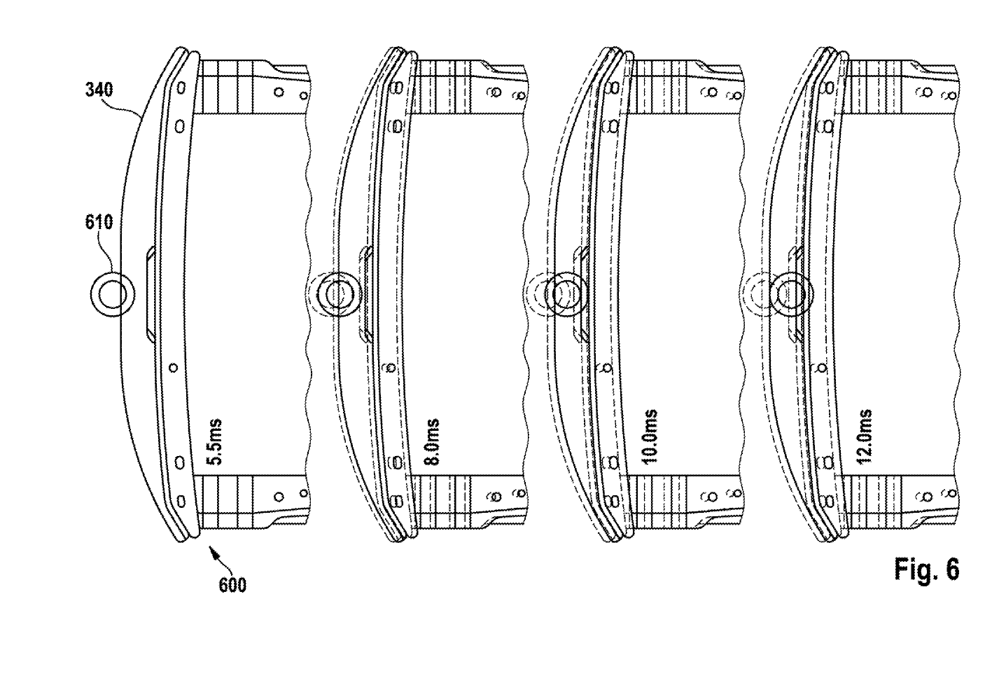

FIG. 6 shows the retraction of a front end structure 600 together with crossbeam 340 during use of the active pedestrian protection device presented herein in direct comparison with a passive system, with reference to an illustration of instantaneous states over a predetermined time period. The illustration in FIG. 6 shows front end structure 600 in contact with a leg impactor 610, which represents a leg of a pedestrian, at points in time 5.5 ms, 8.0 ms, 10 ms, and 12 ms after a collision. Solid lines denote positions of front end structure 600 during use of the active pedestrian protection device presented here, and dashed lines denote positions of front end structure 600 during use of a standard passive structure.

Important criteria for one or multiple necessary actuators for retracting entire front end structure 600 are the provided energy on the one hand, and the recall characteristic of this energy, i.e., time, development, etc., on the other hand. Storing the energy in the pretensioned spring is only one possibility of providing this type of auxiliary actuator system. For example, the energy which is suddenly necessary for retracting the tube, including the front end in the form of crossbeam 340, the foam, etc., may also be provided via a pyrotechnic energy source in an alternative design.

Accordingly, the spring actuator system would change into a pyrotechnic actuator system.

According to the illustration in FIG. 6, when the active structure is used, the advantageous characteristic, depicted by the solid lines, is such that at the point in time of the contact, the relative speed between leg of pedestrian 610 and front end structure 600 is preferably low. The retraction speed optimally corresponds approximately to the vehicle speed here. However, a beneficial effect may be achieved even at other retraction speeds. The retraction speed is now subsequently reduced until it is zero. As a result, pedestrian 610 does not suddenly collide with the vehicle and does not become accelerated to the speed of the vehicle; rather, this process takes place more slowly with correspondingly lower occurring forces and thus a lower risk of injury. This is also indicated by the formula for the force impact: F*t=m*v. Since impulse m*v is constant, occurring force F may be reduced by prolonging contact time t.

Another positive aspect is that the bounce-off speed of pedestrian 610 is reduced by this procedure. Thus, the major risk of a secondary impact is reduced as well. The secondary impact is, for example, a contact of pedestrian 610 with another object such as a roadway or another vehicle when the pedestrian is thrown after the primary collision with the vehicle. In the most favorable case, the collision may occur in a completely inelastic manner, i.e., with no bounce.

The behavior of the adaptive structure during normal collisions (without pedestrian involvement) remains unaffected by the pedestrian protection device described here.

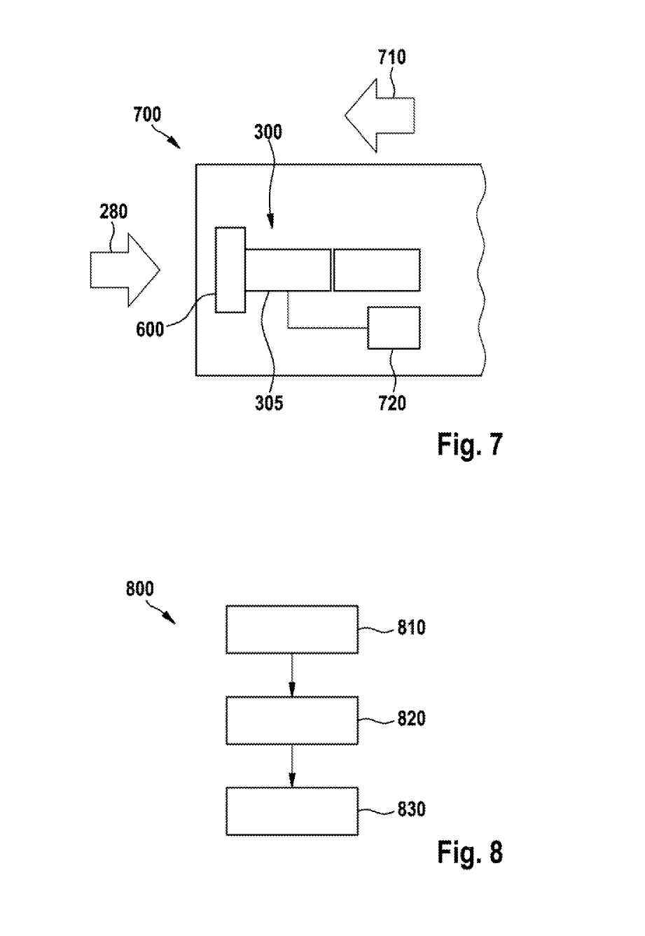

FIG. 7 shows a schematic illustration of a vehicle 700 having adaptive passenger protection device 300 with pedestrian protection from FIGS. 3A and 3B. Passenger protection device 300 is composed of front end structure 600 and adaptive impact absorber 305, and in the present case replaces the front longitudinal chassis beam. An arrow denotes a travel direction 710 of vehicle 700. Another arrow denotes advancing direction 280 in which the impact energy is to be absorbed during a collision of vehicle 700 with a pedestrian. Passenger protection device 300 is coupled to a control unit 720 of vehicle 700 via a line system, for example a CAN bus. Control unit 720 receives an impact signal during a collision of vehicle 700, and on this basis outputs, for example, a signal for enabling the disengageable cavity of impact absorber 305 in order to activate the pedestrian protection of device 300.

FIG. 8 shows a flow chart of one exemplary embodiment of a method 800 for using a pedestrian protection device which is coupleable and/or coupled to a passenger protection device for a vehicle, as explained in detail above. Method 800 is carried out in conjunction with a control unit of the vehicle which is electrically connected to the passenger protection device, the passenger protection device having an impact absorber for absorbing impact energy, and a blocking element for blocking the movement of a deformation element of the impact absorber.

A sensor system of the vehicle detects a collision with a pedestrian and outputs an impact signal to a control unit of the vehicle in a step 810. The control unit outputs an instruction to the passenger protection device in a subsequent step 820 for deactivating the blocking element in order to enable the deformation element for the movement. The deformation element is actively moved in the advancing direction of the passenger protection device with the aid of an actuator in a subsequent step 830 in order to delay the impact of the pedestrian with the vehicle and thus reduce the risk of injury.

The exemplary embodiments which are described and shown in the figures are selected only as examples. Different exemplary embodiments may be combined with one another in their entirety, or with respect to individual features. In addition, one exemplary embodiment may be supplemented with features of another exemplary embodiment.

Furthermore, method steps according to the present invention may be repeated and carried out in a sequence other than that described.

An exemplary embodiment which includes an “and/or” linkage between a first feature and a second feature may be construed in such a way that according to one specific embodiment, the exemplary embodiment includes the first feature as well as the second feature, and according to another specific embodiment includes only the first feature or only the second feature.

1-11. (canceled)

12. A passenger protection device for a vehicle, comprising:
an impact absorber for absorbing impact energy, the impact absorber having a cavity for receiving and deforming a deformation element during a movement of the deformation element in an advancing direction which is determined by the impact energy;
a blocking element for blocking the movement of the deformation element; and
a pedestrian protection device which is (i) configured to be selectively coupled to the deformation element and (ii) configured to actively move the deformation element by a predetermined distance in the advancing direction, based on a deactivation of the blocking element.

13. The passenger protection device as recited in claim 12, wherein the deformation element has a pretapered area, a length of the pretapered area corresponding to a length of the predetermined distance, and a diameter of the deformation element in the pretapered area being less than a clearance of the cavity.

14. The passenger protection device as recited in claim 13, wherein the pedestrian protection device has an actuator which is configured to continually exert a force of motion on the deformation element for moving the deformation element by the predetermined distance.

15. The passenger protection device as recited in claim 14, wherein the actuator is a tension spring, a first end of the tension spring being fastened to the deformation element, and a second end of the tension spring being fastened to an element of the passenger protection device situated upstream from the deformation element in the advancing direction, generating a tensile stress, and a spring excursion of the tension spring in the fastened state corresponding to the predetermined distance of the deformation element.

16. The passenger protection device as recited in claim 15, wherein the pedestrian protection device includes at least one pin which is situated with respect to the spring in such a way that the pin influences a force-displacement characteristic of the spring in a predetermined manner when the blocking element is deactivated.

17. The passenger protection device as recited in claim 12, wherein the pedestrian protection device includes an actuator which is configured to exert a force of motion on the deformation element for moving the deformation element by the predetermined distance in response to an actuation.

18. The passenger protection device as recited in claim 14, wherein the blocking element is a disengageable cavity which is configured to be selectively deactivated by disengagement in response to an impact signal.

19. A method for using a pedestrian protection device configured to be selectively coupled to a passenger protection device of a vehicle, the passenger protection device having an impact absorber for absorbing impact energy, and the impact absorber having a cavity for receiving and deforming a deformation element during a movement of the deformation element in an advancing direction which is determined by the impact energy, and a blocking element for blocking the movement of the deformation element, the method comprising:
selectively deactivating the blocking element in order to enable the deformation element; and
actively moving the deformation element by a predetermined distance in the advancing direction in order to use the pedestrian protection device.

20. The method as recited in claim 19, wherein in the step of actively moving the deformation element, a magnitude of a speed of the movement of the deformation element is reduced from a first speed which approximately corresponds to a speed of the vehicle to a second speed which is approximately zero.

21. A non-transitory, computer-readable data storage medium storing a computer program having program codes which, when executed on a computer, performs a method for using a pedestrian protection device configured to be selectively coupled to a passenger protection device of a vehicle, the passenger protection device having an impact absorber for absorbing impact energy, and the impact absorber having a cavity for receiving and deforming a deformation element during a movement of the deformation element in an advancing direction which is determined by the impact energy, and a blocking element for blocking the movement of the deformation element, the method comprising:
selectively deactivating the blocking element in order to enable the deformation element; and
actively moving the deformation element by a predetermined distance in the advancing direction in order to use the pedestrian protection device.
